(19) United States
(12) Patent Application Publication
(10) Pub. No.: US 2026/0009523 A1
(43) Pub. Date: Jan. 8, 2026

(54) DIFFUSE REFLECTION LIGHT-EMITTING LAMP STRUCTURE

(71) Applicant: Xiamen Topstar Lighting Co., Ltd., Xiamen (CN)

(72) Inventors: Yongjie WU, Xiamen (CN); Yunbiao WU, Xiamen (CN)

(73) Assignee: Xiamen Topstar Lighting Co., Ltd., Xiamen (CN)

(21) Appl. No.: 19/325,412

(22) Filed: Sep. 10, 2025

(30) Foreign Application Priority Data
Aug. 12, 2025 (CN) 202521711202.7

(51) Int. Cl. F21V 19/00; F21V 7/04; F21V 15/015; F21V 29/70; F21Y 115/10

(52) U.S. Cl. CPC F21V 19/0025; F21V 7/04; F21V 15/015; F21V 29/70; F21Y 2115/10

(57) ABSTRACT

A diffuse reflection light-emitting lamp structure includes: a reflector cup, the reflector cup integrally forming one through channel, the through channel extending toward a direction of a cup opening; a light source board, the light source board being disposed at one end of the through channel that is close to the cup opening. Light sources on the light source board are distributed at an outer peripheral side of the through channel, and a light-emitting surface of the light source faces the reflector cup.

### CROSS-REFERENCE TO RELATED APPLICATIONS

This application claims priority to Chinese Patent Application No. 202521711202.7, filed on Aug. 12, 2025, the contents of which are incorporated herein by reference.

### TECHNICAL FIELD

The present disclosure relates to the technical field of lamps, and in particular to a diffuse reflection light-emitting lamp structure.

### BACKGROUND

In the existing lamp field, a conventional lamp emits light in a straight-down manner, that is, a light-emitting direction of a light source faces a light emission surface of the lamp. In addition, in some lamp structures, a diffuser plate structure is further applied to a light emission surface, so that the lamp has a larger diffusion angle, resulting in more serious glare and a problem of easily causing dazzling.

### SUMMARY

The present disclosure relates to a diffuse reflection light-emitting lamp structure, including: a reflector cup, the reflector cup integrally forming one through channel, the through channel extending toward a direction of a cup opening; a light source board, the light source board being disposed at one end of the through channel that is close to the cup opening, and light sources on the light source board are distributed at an outer peripheral side of the through channel, a light-emitting surface of the light source facing the reflector cup.

### BRIEF DESCRIPTION OF THE DRAWINGS

FIG. 1 is an exploded view of a diffuse reflection light-emitting lamp structure in one or more embodiments of the present disclosure.

FIG. 2 is a sectional view of a diffuse reflection light-emitting lamp structure in one or more embodiments of the present disclosure.

FIG. 3 is a structural enlarged view of part A marked in FIG. 2.

FIG. 4 is a front view of a light source board of a diffuse reflection light-emitting lamp structure in one or more embodiments of the present disclosure.

FIG. 5 is a schematic structural diagram of a radiator of a diffuse reflection light-emitting lamp structure in one or more embodiments of the present disclosure.

FIG. 6 is a schematic structural diagram of a light transmission cover of a diffuse reflection light-emitting lamp structure in one or more embodiments of the present disclosure.

FIG. 7 is a schematic structural diagram of a cover plate of a diffuse reflection light-emitting lamp structure in one or more embodiments of the present disclosure.

FIG. 8 is a schematic structural diagram of a whole lamp of a diffuse reflection light-emitting lamp structure in one or more embodiments of the present disclosure.

### DETAILED DESCRIPTION OF THE EMBODIMENTS

In the related art, when a lamp emits light in a straight-down manner, there are problems of glare and easy eye dazzling. To solve the problems of glare and dazzling, light is usually emitted in a diffuse reflection manner. However, when light is emitted in the diffuse reflection manner, there is a problem that light cannot be completely irradiated on a reflector cup. In addition, the light is irradiated on the reflector cup, which causes a rise in an internal temperature of the lamp and easily causes device damage.

The present disclosure provides a diffuse reflection light-emitting lamp structure, and a specific structure is as follows.

A diffuse reflection light-emitting lamp structure includes: a reflector cup 1, the reflector cup 1 integrally forming one through channel 11, the through channel 11 extending toward a direction of a cup opening 12; a light source board 2, the light source board 2 being disposed at one end of the through channel 11 that is close to the cup opening 12, and light sources 21 on the light source board 2 are distributed at an outer peripheral side 111 of the through channel 11, a light-emitting surface 23 of the light source 21 facing the reflector cup 1. The light source 21 on the light source board 2 may includes light emitting diodes (LEDs). The through channel 11 is formed at the reflector cup 1, and the light sources 21 on the light source board 2 are distributed at the outer peripheral side 111 of the through channel 11, so that the light-emitting surface 23 of the light source 21 faces the reflector cup 1, that is, the light source board 2 is invertedly disposed on the through channel 11. The through channel 11 is integrally formed by the reflector cup 1, that is, the through channel 11 also has a diffuse reflection function, so that when the light source 21 emits light toward an interior of the reflector cup 1, light can be completely irradiated on the reflector cup, and then the reflector cup 1 forms a diffuse reflection effect to reflect the light to a light emission surface. Therefore, the problem of glare caused by straight-down light emission of a conventional lamp and the problem that light cannot be completely irradiated on the reflector cup 1 are solved. In an optional implementation, the through channel 11 is at a central position of the reflector cup 1, so that the reflector cup 1 evenly emits light in all directions. In other optional implementations, the through channel 11 is disposed at a preset position, so as to meet different modeling requirements of the lamp.

In some embodiments, a top end of the through channel 11 is not higher than a plane of the cup opening 12 of the reflector cup 1. The top end of the through channel 11 is set to be not higher than the plane of the cup opening 12 of the reflector cup 1, so as to avoid the through channel 11 being too high to block light. If the top end of the through channel 11 has a too high height, the radiator 3 will also need to be raised, and an area of a top end of the radiator 3 is reduced, thereby causing a poor effect by the radiator 3. In addition, a distance from the light source 21 to the bottom of the reflector cup 1 is shortened, so that the light-emitting surface 23 is close to the bottom of the reflector cup 1 to form better diffuse reflection.

In some embodiments, the diffuse reflection light-emitting lamp structure further includes a radiator 3, at least a part of the radiator 3 being disposed within the through channel 11; the light source board 2 is assembled on the radiator 3. A part of the radiator 3 is disposed within the through channel 11, and is connected to the light source board 2, so as to dissipate heat generated by the light source board 2 to the outside of the reflector cup 1, thereby improving a heat dissipation effect of the lamp.

In some embodiments, at least a part of the radiator 3 is attached to the through channel 11. A part of the radiator 3 is attached to the through channel 11, that is, the through channel 11 of the reflector cup 1 is not completely attached to the radiator 3, so as to avoid forming interference between the through channel 11 and the radiator 3 during installation.

In some embodiments, the radiator 3 is a conoid; a top of the radiator 3 passes through the through channel 11 to be connected to the light source board 2. The radiator 3 is set as a conoid, thereby reducing a volume of the through channel 11, so that a light emission area of the cup opening 12 of the reflector cup 1 is larger.

In some embodiments, the diffuse reflection light-emitting lamp structure further includes a driver 4, the driver 4 being assembled at one end of the radiator 3 that is away from the light source board 2. The driver 4 is disposed, so that different functions of the light source 21 are controlled by a circuit on the driver 4.

In some embodiments, one end of the radiator 3 that is connected to the light source board 2 is provided with a window 31; the driver 4 is electrically connected by the window 31 to the light source board 2. The window 31 structure is disposed on the radiator 3, which facilitates connection between the driver 4 and the light source board 2. Therefore, an electrical connection channel is formed between the driver 4 and the light source board 2, enabling the driver 4 to perform power supply and function control to the light source board 2.

In some embodiments, the light sources 21 on the light source board 2 are uniformly spaced around the outer peripheral side 111 of the through channel 11. That is, the light sources 21 on the light source board 2 are evenly distributed at the outer peripheral side 111 of the through channel 11, so that light is evenly emitted in all directions.

In some embodiments, the diffuse reflection light-emitting lamp structure further includes: a cover plate 5, the cover plate 5 being disposed at a backlight surface 22 of the light source board 2; a light transmission cover 6, the light transmission cover 6 being disposed at a light-emitting surface 23 of the light source board 2. The light transmission cover 6 is disposed at the light-emitting surface 23 of the light source board 2, so as to play a role in transmitting light and isolating and protecting the light source board 2; and the cover plate 5 is disposed at the backlight surface 22 of the light source board 2, so as to play a role in blocking an internal structure of the lamp and isolating and protecting the light source board 2 to prevent from making contact with the charged light source board 2.

In some embodiments, one side of the cover plate 5 that faces the light transmission cover 6 is provided with a connecting portion 51; one side of the light transmission cover 6 that faces the cover plate 5 is provided with a connection fitting portion 61; the connecting portion 51 is detachably connected to the connection fitting portion 61. The connecting portion 51 is disposed on the cover plate 5, and a connection fitting portion 61 is disposed on the light transmission cover 6, respectively, so that a detachable fitting is formed between the cover plate 5 and the light transmission cover 6 to facilitate assembly.

The following embodiment is a specific implementation solution.

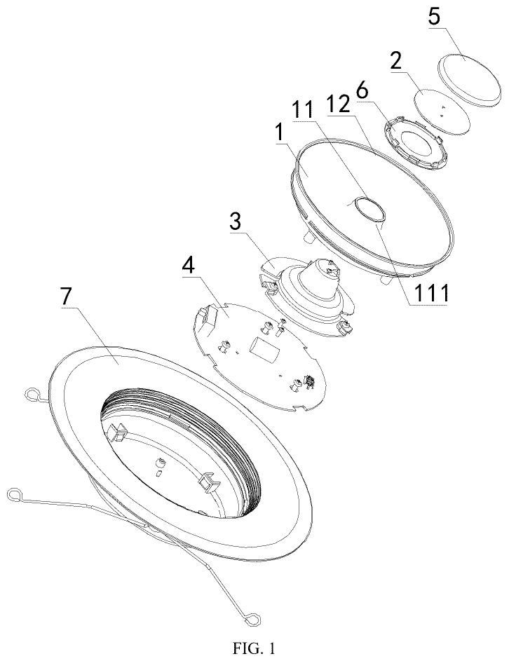

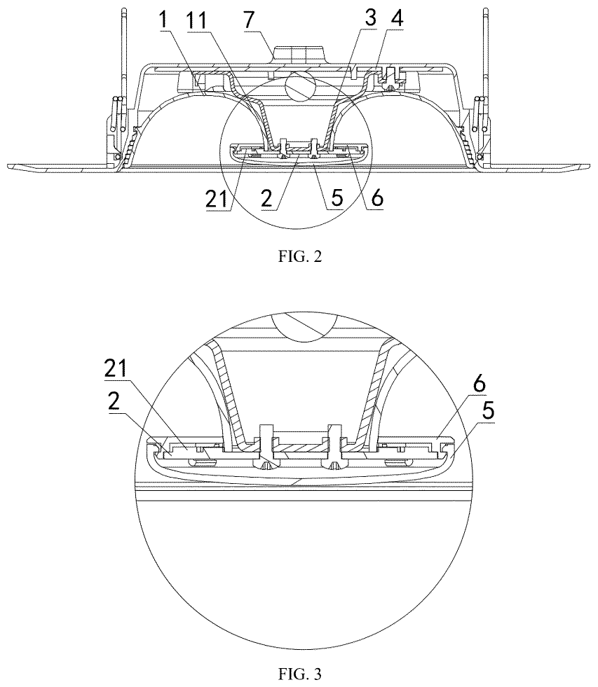

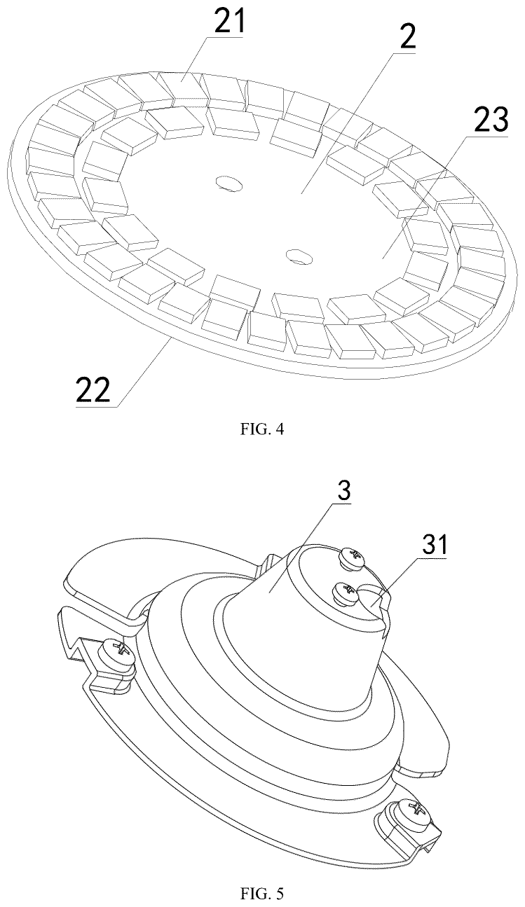

In one or more embodiments, with reference to FIG. 1 to FIG. 3, a diffuse reflection light-emitting lamp structure includes: a reflector cup 1, the reflector cup 1 integrally forming one through channel 11, the through channel 11 extending toward a direction of a cup opening 12; a light source board 2, the light source board 2 being disposed at one end of the through channel 11 that is close to the cup opening 12, and light sources 21 on the light source board 2 are distributed at an outer peripheral side 111 of the through channel 11, a light-emitting surface 23 of the light source 21 facing the reflector cup 1. The light-emitting surface 23 of the light source board 2 is attached to an opening of the through channel 11. As shown in FIG. 2, a top end of the through channel 11 is not higher than a plane of the cup opening 12 of the reflector cup 1. As shown in FIG. 4, the light sources 21 on the light source board 2 are uniformly spaced and annularly arranged. The reflector cup I may be formed by injection molding and surface coarse grit finishing as leather grain textured. Or the reflector cup 1 may be formed by metal spinning and surface sandblasting. A better diffuse reflection effect may be formed by adopting surface coarse grit finishing.

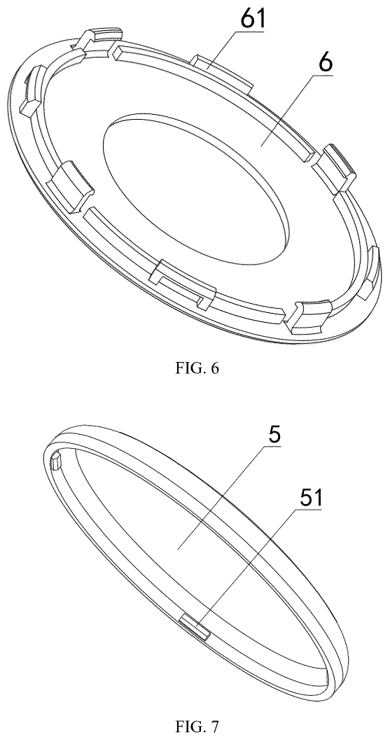

The diffuse reflection light-emitting lamp structure further includes a radiator 3 and a driver 4, at least a part of the radiator 3 being disposed within the through channel 11; and at least a part of the radiator 3 is attached to the through channel 11. The light source board 2 is assembled on the radiator 3; the driver 4 is assembled at one end of the radiator 3 that is away from the light source board 2. With reference to FIG. 5, the radiator 3 in this embodiment is a conoid; a top of the radiator 11 passes through the through channel 11 to be connected to the light source board 2. In addition, one end of the radiator 3 that is connected to the light source board 2 is provided with a window 31; the driver 4 is electrically connected by the window 31 to the light source board 2.

The diffuse reflection light-emitting lamp structure further includes a cover plate 5 and a light transmission cover 6, the cover plate 5 being disposed at a backlight surface 22 of the light source board 2; the light transmission cover 6 is disposed at a light-emitting surface 23 of the light source board 2. With reference to FIG. 6 and FIG. 7, one side of the cover plate 5 that faces the light transmission cover 6 is provided with a connecting portion 51; one side of the light transmission cover 6 that faces the cover plate 5 is provided with a connection fitting portion 61; the connecting portion 51 is detachably connected to the connection fitting portion 61.

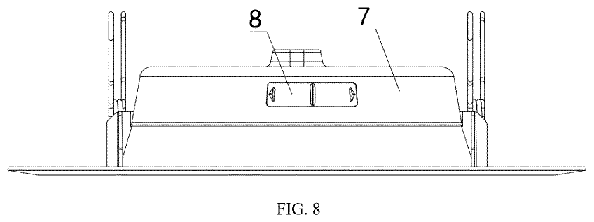

With reference to FIG. 1 and FIG. 8, the diffuse reflection light-emitting lamp structure further includes a housing 7, the foregoing structures being all disposed within the housing 7, so that the housing 7 plays a role in protecting the foregoing structures. In addition, a surface of the housing 7 is provided with a toggle switch 8. The toggle switch 8 is connected to the driver 4, which in turn controls a circuit on the driver 4 to output different control signals to the light source board 2, so that the light source board 2 forms different light effects.

In conclusion, in one or more embodiments, the reflector cup 11 having the through channel 11 is combined with the radiator 3 of a conoid. At least a part of the radiator 3 is attached to the through channel 11, and the light source board 2 is invertedly disposed on the radiator 3. A diffuse reflection effect is formed by the reflector cup 1 to reflect light to the light emission surface, solving the problem of glare caused by straight-down light emission of a conventional lamp. Meanwhile, heat from the light source board 2 and the reflector cup 1 is dissipated by the radiator 3, improving the heat dissipation effect by the lamp.

The above are merely the embodiments of the present disclosure and do not therefore limit the patent scope of the present disclosure. Any equivalent transformation based on the specification and the drawings of the present disclosure, either directly or indirectly applied in other related technical fields, shall be similarly included in the patent protection scope of the present disclosure.

What is claimed is:

1. A diffuse reflection light-emitting lamp structure, comprising:
a reflector cup, integrally forming one through channel, the through channel extending toward a direction of a cup opening; and
a light source board, disposed at one end of the through channel that is close to the cup opening, light sources on the light source board being distributed at an outer peripheral side of the through channel, and a light-emitting surface of the light source facing the reflector cup.

2. The diffuse reflection light-emitting lamp structure according to claim 1, wherein a top end of the through channel is not higher than a plane of the cup opening of the reflector cup.

3. The diffuse reflection light-emitting lamp structure according to claim 1, further comprising:
a radiator, at least a part of the radiator being disposed within the through channel;
wherein the light source board is assembled on the radiator.

4. The diffuse reflection light-emitting lamp structure according to claim 3, wherein at least a part of the radiator is attached to the through channel.

5. The diffuse reflection light-emitting lamp structure according to claim 4, wherein the radiator is a conoid; and
a top of the radiator passes through the through channel to be connected to the light source board.

6. The diffuse reflection light-emitting lamp structure according to claim 4, further comprising:
a driver, assembled at one end of the radiator that is away from the light source board.

7. The diffuse reflection light-emitting lamp structure according to claim 6, wherein one end of the radiator that is connected to the light source board is provided with a window; and
the driver is electrically connected by the window to the light source board.

8. The diffuse reflection light-emitting lamp structure according to claim 1, wherein the light sources on the light source board are uniformly spaced around the outer peripheral side of the through channel.

9. The diffuse reflection light-emitting lamp structure according to claim 1, further comprising:
a cover plate, disposed at a backlight surface of the light source board; and
a light transmission cover, disposed at a light-emitting surface of the light source board.

10. The diffuse reflection light-emitting lamp structure according to claim 9, wherein one side of the cover plate that faces the light transmission cover is provided with a connecting portion;
one side of the light transmission cover that faces the cover plate is provided with a connection fitting portion; and
the connecting portion is detachably connected to the connection fitting portion.
